(19) United States
(12) Patent Application Publication
(10) Pub. No.: US 2009/0140834 A1
(43) Pub. Date: Jun. 4, 2009

(54) APPARATUS HAVING PASSIVE WIRELESS SWITCH AND OPERATING METHOD THEREOF

(75) Inventors: Lih-Guong Jang, Hsinchu City (TW); Hung-Ren Huang, Tainan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/022,116

(22) Filed: Jan. 29, 2008

(30) Foreign Application Priority Data
Dec. 3, 2007 (TW) 96145915

(51) Int. Cl. G08C 19/00

(52) U.S. Cl. 340/5.1

(57) ABSTRACT

An apparatus having a passive wireless switch is provided. The apparatus includes a device system, a device switch, a passive wireless switch, and an antenna module. The passive wireless switch includes a microprocessor, a discrete signal-outputting unit, and a charge module. When the charge module is charged to enable the micro-processor by receiving a radio frequency wireless electric wave, the micro-processor may match an identification code contained in the RF signal with the identification code of the passive wireless switch. If the identification code contained in the RF signal is the same as the identification code of the passive wireless switch, the discrete signal-outputting unit may output a discrete signal to the device switch, so as to enable the device system. Accordingly, it is possible to reduce the power consumption of the apparatus during a standby mode, so as to improve a utilization efficiency of power supply.

### CROSS-REFERENCE TO RELATED APPLICATION

This application claims the priority benefit of Taiwan application serial no. 96145915, filed on Dec. 3, 2007. The entirety of the above-mentioned patent application is hereby incorporated by reference herein and made a part of this specification.

### BACKGROUND OF THE INVENTION

1. Field of the Invention

The present invention relates to an apparatus having a wireless switch and an operating method thereof. More particularly, the present invention relates to an apparatus having a passive wireless switch and an operating method thereof.

2. Description of Related Art

With development of technology, wireless remote control electronic apparatus and wireless communication apparatus with diversified function are widely used in our daily life. Synchronous correction need to be performed periodically to a general wireless communication apparatus, in which the system thereof may provide power supply for a switching circuit of the wireless communication apparatus, so as to maintain a normal operation of the switching circuit of the wireless communication apparatus. Namely, even if an electronic switching system is in a standby mode, power required for an operation mode thereof is still provided. Therefore, only 10% of the power for such kind of electronic switching system is used for data calculation and data transmission, and 90% of the power is wasted in the standby mode.

Moreover, an optical coupling switch is generally applied to a household appliance to function as a wireless switch thereof. Similar to the wireless communication apparatus, the apparatus using the optical coupling switch also requires the power supply under the standby mode to maintain a normal operation of the optical coupling switch. Therefore, power consumption of such kind of apparatus under the standby mode needs to be reduced, so as to improve a utilization efficiency of power supply.

### SUMMARY OF THE INVENTION

The present invention generally relates to an apparatus having a passive wireless switch, which may greatly reduce power consumption under a standby mode, and improve a utilization efficiency of a power supply thereof.

The present invention generally relates to an operating method for an apparatus having a passive wireless switch, which may greatly reduce power consumption of the apparatus under a standby mode, and improve a utilization efficiency of a power supply thereof.

An exemplary apparatus example consistent with the invention including a device system, a device switch, a passive wireless switch, and an antenna module. The device system is used for controlling operations of the apparatus. The device switch is electrically connected to the device system for turning on/off the device system. The passive wireless switch is electrically connected to the device switch for turning on/off the device switch. The passive wireless switch includes a microprocessor, a discrete signal-outputting unit and a charge module. The microprocessor has an identification code and is used for controlling a whole operation of the passive wireless switch, and may identify whether or not an identification code contained in a radio frequency (RF) signal matches the identification code of the passive wireless switch. The discrete signal-outputting unit is electrically connected to the microprocessor for outputting a discrete signal to the device switch. The charge module is electrically connected to the microprocessor and may be charged to function as a power supply for the microprocessor by receiving the RF signal. The antenna module is electrically connected to the charge module and is used for receiving the RF signal. When the charge module is charged to enable the microprocessor by receiving the RF signal, the microprocessor compares the identification code contained in the RF signal with the identification code of the passive wireless switch. If the identification code contained in the RF signal is the same to the identification code of the passive wireless switch, the discrete signal-outputting unit outputs the discrete signal to the device switch, and the device switch enables the device system after receiving the discrete signal.

The present invention provides an operating method for a passive wireless switch, which is suitable for an apparatus having the passive wireless switch. An exemplary example of the operating method consistent with the invention is as follows. Receiving a RF signal and generating a current by inductive coupling, so as to enable a passive wireless switch. Judging whether or not an identification code contained in the RF signal is matched with an identification code of the passive wireless switch, and outputting a discrete signal if the identification code contained in the RF signal is the same as the identification code of the passive wireless switch.

In an exemplary example consistent with the present invention, a passive wireless switch structure is applied, so that the electronic apparatus may have no power consumption during a long standby mode, and therefore energy is saved.

In order to make the aforementioned and other objects, features and advantages of the present invention comprehensible, an exemplary example consistent with the invention accompanied with figures is described in detail below.

### BRIEF DESCRIPTION OF THE DRAWINGS

FIG. 1 is a block diagram illustrating an apparatus having a passive RF switch according to an exemplary example consistent with the present invention.

FIG. 2 is a block diagram illustrating an apparatus having a passive RF switch according to another exemplary example consistent with the present invention.

FIG. 3 is a diagram illustrating an exemplary example of system communication procedure consistent with the present invention for the apparatus of FIG. 1.

FIG. 4 is a flowchart illustrating an operating method of a passive wireless switch according to an exemplary example consistent with the present invention.

### DESCRIPTION OF EMBODIMENTS

Radio frequency identification (RFID) is an automatic identification technique which may identify an object by RF wireless electric waves. An operational principle of the RFID is to read an electronic tag planted within or attached to the object via a reader, so as to identify or capture wireless data thereof. The electronic tags include active tags and passive tags grouped based on whether or not a battery is contained therein. The passive tag may induct energy of the RF wireless electric wave sent from the reader, and when the passive tag inducts such energy, an antenna module thereof may generate a current by inductive coupling, so as to charge a capacitor therein to form an applicable power supply. Then, data stored in chips of the passive tag may be transmitted to the reader via built-in wireless electric wave. In an exemplary example of the present invention, by applying the passive tag and outputting discrete signals, a passive wireless switching device without power consumption during the standby mode is provided, such that power consumption during the standby mode is effectively reduced.

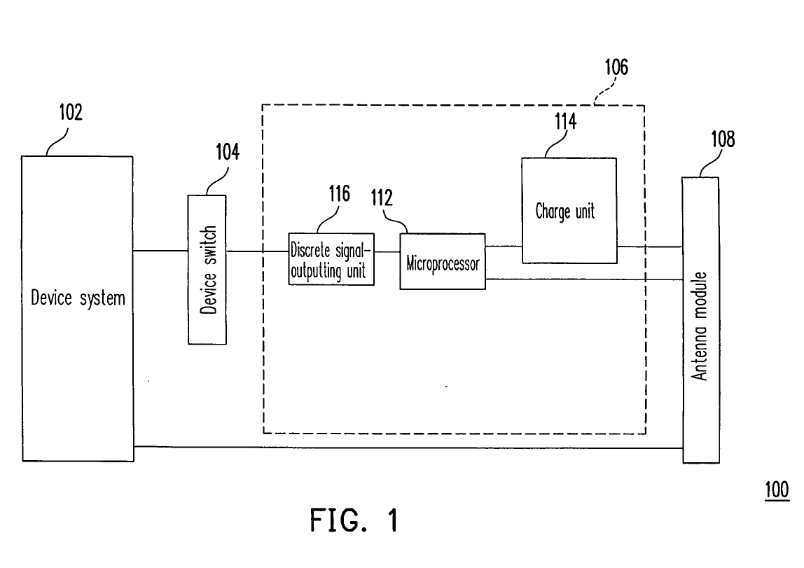

FIG. 1 is a block diagram illustrating an apparatus having a passive RF switch according to an exemplary embodiment of the present invention.

Referring to FIG. 1, the apparatus 100 having a passive wireless switch includes a device system 102, a device switch 104, a passive wireless switch 106 and an antenna module 108.

The device system 102 is used for controlling a whole operation of the apparatus 100. In the present embodiment, the device system 102 may be a wireless network device system or a wireless remote control electrical system.

The device switch 104 is electrically connected to the device system 102 for turning on/off the device system 102. Namely, the device system 102 is turned on/off by the device switch 104. For example, the device switch 104 is a complementary metal-oxide-semiconductor (CMOS) switch.

The passive wireless switch 106 is electrically connected to the device switch 104 for turning on/off the device switch 104. In detail, the passive wireless switch 106 may be enabled by receiving a RF signal to turn on the device switch 104 and further turn on the device system 102. The RF signal includes various RF bands of signals such as low frequency (LF) signal, high frequency (HF) signal, ultra high frequency (UHF) signal or microwave signal. In the present embodiment, the passive wireless switch 106 may control the device system 102 to enter a deep sleep mode, so as to avoid demanding of periodic system synchronous correction and improve a utilization efficiency of the power supply. Composition and operating method of the passive wireless switch 106 will be described in detail below with reference of figures.

The passive wireless switch 106 includes a microprocessor 112, a charge module 114 and a discrete signal-outputting unit 116.

The microprocessor 112 has an identification code of the passive wireless switch 106, and may control a whole operation of the passive wireless switch 106, such as control of operation frequency, data transmission rate, signal modulation and memory access etc. Particularly, the microprocessor 112 may identify whether or not an identification code contained in the RF signal matches the identification code of the passive wireless switch 106.

The charge module 114 is electrically connected to the microprocessor 112. The charge module 114 includes a charge capacitor (not shown), which may be charged by the RF signal to enable the microprocessor 112. In detail, a remote wireless device (not shown) may provide wireless electric wave energy to the charge module 114, and the charge module 114 may receive and store such energy as a power supply for providing power to the microprocessor.

In the present embodiment, the RF signal has a wireless communication protocol, and the aforementioned identification code is defined within the wireless communication protocol.

The discrete signal-outputting unit 116 is electrically connected to the microprocessor 112, and may output a discrete signal. The device switch 104 receives the discrete signal, and may be turned on/off in response to the discrete signal.

The antenna module 108 is electrically connected to the charge module 114 for receiving energy of the RF signal and transceiving data.

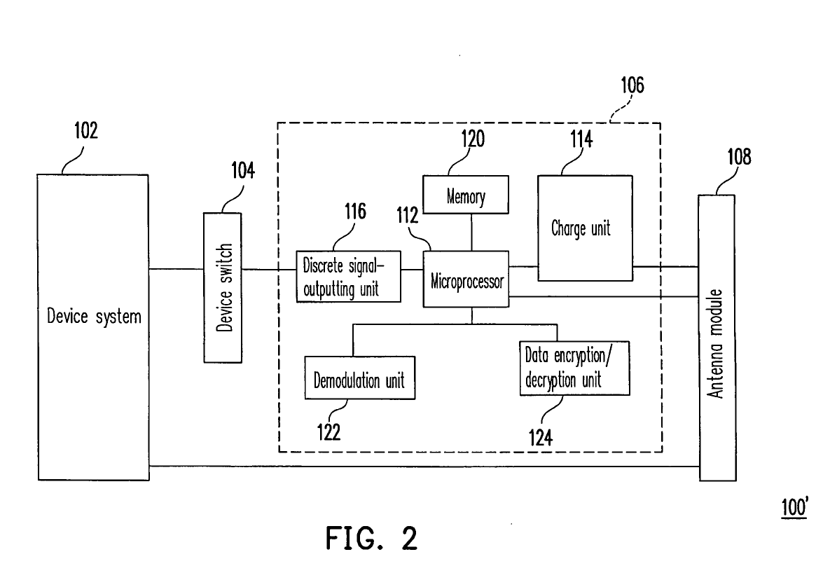

Since the RF signal may be influenced by noise and distortion during transmission, digital data transmitted by modulated signal from a transmitter is generally encrypted, and at a receiving terminal, the modulated signal is demodulated and decrypted. Therefore, in another exemplary embodiment of the present invention, the passive wireless switch 106 further includes a demodulation unit 122 (shown as a device 100′ of FIG. 2) electrically connected to the microprocessor for demodulating the received RF signal.

In another embodiment of the present invention, the passive wireless switch 106 further includes a data encryption/decryption unit 124 (shown as a device 100′ of FIG. 2) electrically connected to the microprocessor 112 for encrypting or decrypting the data transmitted by the RF signal.

In another embodiment of the present invention, the passive wireless switch 106 further includes a memory 120 (shown as a device 100′ of FIG. 2) for storing the aforementioned identification code. For example, the memory 120 may be a read only memory (ROM), a write-once read-many (WORM) memory or a non-volatile memory. In case of the WORM memory, a user may renew the data stored in the memory 120 for once, and in case of the non-volatile memory, the user may repeatedly renew the data stored in the memory 120. Therefore, in case of the renewable memory, the user may perform customized settings of related information of the passive wireless switch 106, such as the identification code and accessing password etc.

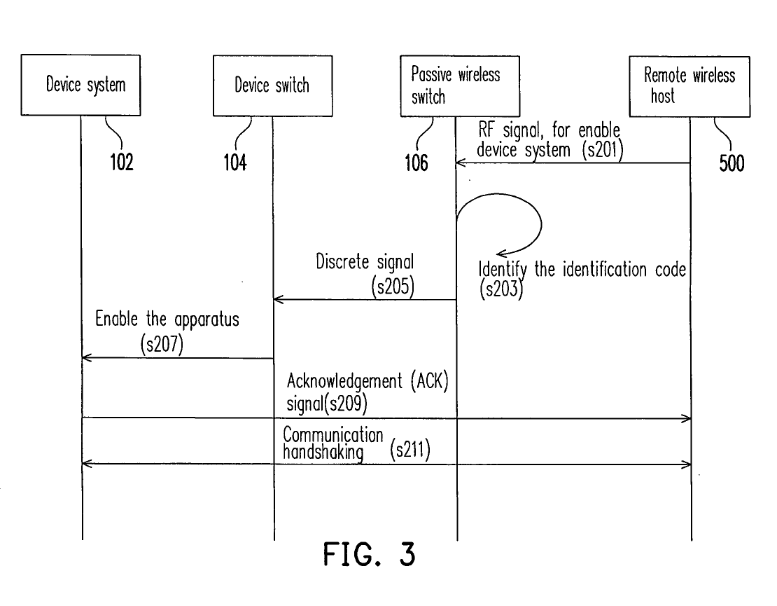

FIG. 3 is a diagram illustrating a system communication procedure for the apparatus of FIG. 1. In the present invention, a remote wireless host 500 sends a RF signal (S201). The charge unit 114 of the passive wireless switch 106 may be charged via the RF signal, so as to enable the microprocessor 112. Next, the microprocessor 112 compares the identification code contained in the RF signal to the identification code of the passive wireless switch 106 (S203). If the identification code contained in the RF signal is the same as the identification code of the passive wireless switch 106, the discrete signal-outputting unit 116 of the passive wireless switch 106 outputs a discrete signal to the device switch 104 (S205), and the device switch 104 enables the device system 102 after receiving the discrete signal (S207). Next, the device system 102 responds an acknowledgement (ACK) signal to the remote wireless host 500 (S209). Next, a communication handshaking procedure is performed (S211). Based on such method, the electronic apparatus of the present invention may enter the deep sleep mode when the electronic apparatus is in a non-working state, so as to save the power consumption. In case of the wireless communication device, utilization efficiency of the battery of the wireless communication device may further be improved.

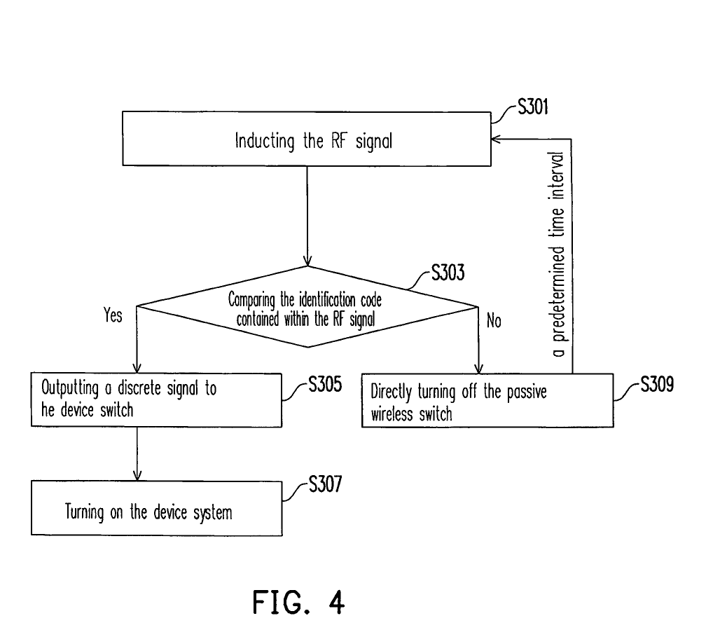

FIG. 4 is a flowchart illustrating an exemplary operating method of a passive wireless switch according to an embodiment of the present invention.

Referring to FIG. 4, in step S301, when the antenna module 108 receives the RF signal, a current is generated by inductive coupling to enable the passive wireless switch 106. To be specific, the current enables the processor 112 of the passive wireless switch 106.

Next, in step S303, whether or not the identification code contained in the RF signal matches the identification code of the passive wireless switch 106 is judged. Since the RF signal may be influenced by noise and distortion during transmission, digital data transmitted by modulated signal from a transmitter is generally encrypted. Therefore, signal to be transmitted is generally modulated, and is demodulated at the receiving terminal. Thus, in another embodiment of the present invention, a step (not shown) of demodulating the RF signal may be first performed before the step S303.

If, in the step S303, the identification code contained in the RF signal is judged to be the same as the identification code of the passive wireless switch 106, the passive wireless switch 106 then outputs a discrete signal to the device switch 104 (step S305).

In step S307, the device switch 104 enables the device system 102 after receiving the discrete signal. Next, the device system 102 responds an ACK signal and performs a communication handshaking procedure after being enabled.

In the present embodiment, operating method of the passive wireless switch further includes that when the identification code contained in the RF signal is judged to be different to the identification code of the passive wireless switch 106, the passive wireless switch 106 is then directly turned off (step S309), and after a predetermined time interval, the passive wireless switch 106 again receives the RF signal, namely, the step S301 is repeated.

In another exemplary embodiment of the present invention, the operating method of the passive wireless switch further includes encrypting/decrypting data transmitted by the RF signal, so as to maintain a security of the data transmitted by the RF signal.

In summary, the passive wireless switch provided by the present invention applies the RF signal transmitted from the remote host as the working power supply. Therefore, since electronic switch thereof is driven by an inductive current generated by the RF signal sent from the remote host, power consumption of the system power may be completely avoided. Moreover, when the present invention is applied to the wireless network device, power consumption due to periodic system synchronous correction of the wireless network device is avoided, and power consumption of the wireless network device in the standby mode is reduced, and meanwhile serve time of the battery within the wireless network device is prolonged. Moreover, the passive wireless switch of the present invention has a unique identification code, which may support different signal modulations and coding types.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus having a passive wireless switch, comprising:
a device system, for controlling operations of the apparatus;
a device switch, electrically connected to the device system for turning on/off the device system;
a passive wireless switch, electrically connected to the device switch for turning on/off the device switch, and the passive wireless switch comprising:
a memory, for storing an identification code of the passive wireless switch;
a microprocessor, having an identification code, for controlling a whole operation of the passive wireless switch and judging whether or not an identification code contained in a radio frequency (RF) signal matches the identification code of the passive wireless switch;
a discrete signal-outputting unit, electrically connected to the microprocessor for outputting a discrete signal to the device switch; and
a charge module, electrically connected to the microprocessor for being charged by the RF signal, so as to function as a working power supply for the microprocessor; and
an antenna module, electrically connected to the charge module for receiving the RF signal,
wherein when the charge module is charged by the FR signal and turns on the microprocessor, the microprocessor compares the identification code contained in the RF signal to the identification code of the passive wireless switch, and
wherein if the identification code contained in the RF signal is the same to the identification code of the passive wireless switch, the discrete signal-outputting unit outputs the discrete signal to the device switch, and the device switch enables the device system after receiving the discrete signal.

2. The apparatus having a passive wireless switch as claimed in claim 1, wherein the RF signal comprises a wireless communication protocol, and the identification code is defined within the wireless communication protocol.

3. The apparatus having a passive wireless switch as claimed in claim 1, wherein the passive wireless switch further comprises a demodulation unit electrically connected to the microprocessor for demodulating the received RF signal.

4. The apparatus having a passive wireless switch as claimed in claim 1, wherein the passive wireless switch further comprises a data encryption/decryption unit electrically connected to the microprocessor for encrypting/decrypting data within the RF signal.

5. The apparatus having a passive wireless switch as claimed in claim 1, wherein the device system comprises a wireless network device system or a wireless remote control electrical system.

6. The apparatus having a passive wireless switch as claimed in claim 1, wherein the RF signal comprises various RF bands of signals.

7. An operating method for a passive wireless switch, suitable for an apparatus having the passive wireless switch, comprising:
receiving a RF signal and generating a current by inductive coupling so as to enable the passive wireless switch;
judging whether or not an identification code contained in the RF signal matches an identification code of the passive wireless switch; and
outputting a discrete signal if the identification code contained in the RF signal is the same as the identification code of the passive wireless switch.

8. The operating method for a passive wireless switch as claimed in claim 7, wherein the step of outputting the discrete signal comprises:
outputting the discrete signal to a device switch of the apparatus; and
turning on the apparatus.

9. The operating method for a passive wireless switch as claimed in claim 7 further comprising: directly turning off the passive wireless switch if the identification code contained in the RF signal is judged to be different from the identification code of the passive wireless switch, and again receiving a RF signal after a predetermined time interval.

10. The operating method for a passive wireless switch as claimed in claim 7 further comprising a step of demodulating the RF signal.

11. The operating method for a passive wireless switch as claimed in claim 7 further comprising a step of encrypting/decrypting data within the RF signal.

12. The operating method for a passive wireless switch as claimed in claim 7, wherein the RF signal comprises a wireless communication protocol, and the identification code is defined within the wireless communication protocol.

13. The operating method for a passive wireless switch as claimed in claim 7, wherein the device system comprises a wireless network device system or a wireless remote control electrical system.
